(19) United States
(12) Patent Application Publication
(10) Pub. No.: US 2021/0197026 A1
(43) Pub. Date: Jul. 1, 2021

(54) WORKOUT-TRAINING METHOD

(71) Applicant: Holly Kerslake, Laguna Beach, CA (US)

(72) Inventor: Holly Kerslake, Laguna Beach, CA (US)

(21) Appl. No.: 17/135,780

(22) Filed: Dec. 28, 2020

Related U.S. Application Data
(60) Provisional application No. 62/953,832, filed on Dec. 26, 2019.

(51) Int. Cl. A63B 24/00

(52) U.S. Cl. CPC A63B 24/0087; A63B 2214/00; A63B 2024/0093

(57) ABSTRACT

Systems, methods, and non-transitory computer readable media configured to generate a plurality of exercise movements in a sequence. A user can be provided with each exercise movement of the plurality of exercise movements according to the sequence. The user's memory can be challenged by prompting the user to: (1) identify each exercise movement in the sequence in original order, (2) identify each exercise movement in the sequence in reverse order, (3) identify an exercise movement that comes before or after a particular exercise movement in the sequence, (4) identify an exercise movement having a particular position in the sequence, (5) identify a total number of exercise movements in the sequence, (6) identify exercise movements that are in the sequence or not in the sequence, or (7) unscramble a scrambled list of exercise movements according to the original order.

### CROSS-REFERENCE TO RELATED APPLICATION

This application is a non-provisional of and claims priority to U.S. Provisional Patent Application No. 62/953,832, filed on Dec. 26, 2019 and entitled “WORKOUT-TRAINING METHOD,” the entire contents of which are incorporated herein by reference.

### FIELD OF THE INVENTION

This invention relates generally to workout methods and, more particularly, to exercise and braining-training methods combined to improve memory, overall cognitive function, the cardiovascular system, the musculature system, and coordination.

### BACKGROUND

Exercise is important to maintaining a healthy body. Indeed, people have gathered to improve their physical fitness since the ancient Greeks at the gymnasia. It is becoming increasingly clear that physical exercise also improves mental health, including memory. However, in the past, physical exercise programs have focused on physical fitness, and any benefits to mental health have been a mere byproduct of the physical exercise itself. Thus, there exists a need for an improved workout method that provides a direct benefit to memory, without compromising the exercise routine's ability provide its normal function of improving a person's physical health and fitness. The present invention fulfills this need and provides further related advantages.

### BRIEF SUMMARY OF THE INVENTION

Various embodiments of the present technology can include systems, methods, and non-transitory computer readable media configured to generate a plurality of exercise movements in a sequence. A user can be provided each exercise movement of the plurality of exercise movements according to the sequence. The user's memory can be challenged by prompting the user to: (1) identify each exercise movement in the sequence in original order, (2) identify each exercise movement in the sequence in reverse order, (3) identify an exercise movement that comes before or after a particular exercise movement in the sequence, (4) identify an exercise movement having a particular position in the sequence, (5) identify a total number of exercise movements in the sequence, (6) identify exercise movements that are in the sequence or not in the sequence, or (7) unscramble a scrambled list of exercise movements according to the original order.

In one embodiment, at least one performing aid including performances of the plurality of exercise movements in the sequence can be provided. A plurality of names can be provided. Each name of the plurality of names can correspond to a respective exercise movement. The user can be prompted to follow the at least one performing aid.

In one embodiment, the at least one performing aid is stopped before the challenging the user's memory of the sequence.

In one embodiment, a list of names or icons of the plurality of exercise movements can be provided in an order of the sequence.

In an embodiment, the user can be prompted to perform the plurality of exercise movements on a mirror side.

In one embodiment, a plurality of names or icons that corresponds to the plurality of exercise movements can be provided. The prompting the user to identify the exercise movement can comprise prompting the user to identify the name or the icon that corresponds to the exercise movement.

In one embodiment, the prompting the user to identify the exercise movement can comprise: providing the name and prompting the user to identify the icon that corresponds to the name; or providing the icon and prompting the user to identify the name that corresponds to the icon.

In one embodiment, the prompting the user to identify exercise movements that are in the sequence can comprise providing a list including the plurality of exercise movements and additional exercise movements not in the sequence.

In one embodiment, a score can be generated based on whether the user has successfully identified the exercise movement.

In one embodiment, a set of exercise movements that the user has not successfully identified can be tracked. A subset of the plurality of exercise movements can be generated based on the set of exercise movements.

In one embodiment, a plurality of names that corresponds to the plurality of exercise movements can be provided. A microphone can be provided to the user. The prompting the user to identify the exercise movement can comprise prompting to user to announce a name that corresponds to the exercise movement into the microphone. The name can be received from the user via the microphone.

In one embodiment, a plurality of performing aids including performances of the plurality of exercise movement can be provided. A camera can be provided to the user. The prompting the user to identify the exercise movement can comprise prompting to user to perform the exercise movement. The user's performance can be received via the camera.

In one embodiment, a pose or posture of the user's performance can be evaluated using image recognition. A suggestion to improve the pose or posture can be provided.

In one embodiment, a plurality of performing aids including performances of the plurality of exercise movement can be provided. At least one controller can be provided to the user. The prompting the user to identify the exercise movement can comprise prompting to user to perform the exercise movement. The user's performance can be received via the at least one controller.

In one embodiment, a breakout time can be provided before the challenging the user's memory of the sequence.

In one embodiment, at least one new movement can be added to the plurality of exercise movements. The plurality of exercise movements in the sequence can be updated to include the new movement.

In one embodiment, the user can be prompted to perform an exercise movement not in the sequence.

In one embodiment, the challenging the user's memory of the sequence can comprise providing at least one hint in association with a correct answer.

Some embodiments use dance movements, but the movements in a taught sequence can in other embodiments include calisthenics, high intensity interval training (HIIT), yoga poses, resistance training, or another form of movement that can be broken into individual steps. All of these movements can be considered exercise movements. Different forms of identifications of the exercise movements, such as verbal or visual identifications, can be substituted without departing from the scope of the disclosure. For example, arbitrary names, made-up names, common dance-step names, common yoga names, or another word or sound to identify a movement can be used without departing from the scope of the disclosure. It will be appreciated by those skilled in the art that the use of novel arbitrary names or sounds can be used to increase the difficulty of the cognitive exercises. Therefore, in some embodiments, any form of movement that can be broken into individual steps and any form of verbal identification can be substituted without departing from the scope of the disclosure. In addition, the movements can be performed standing, sitting in a chair, on a floor, on exercise equipment, or in any form that allows a user to perform the movements as disclosed.

Each feature or concept outlined above is independent, and can be combined with the other features or concepts outlined above or with any other feature or concept disclosed in this application. Other features and advantages of the invention should become apparent from the following description of the preferred embodiments, taken in conjunction with the accompanying drawings, which illustrate, by way of example, the principles of the invention.

### BRIEF DESCRIPTION OF THE DRAWINGS

FIG. 1 illustrates an example system including a workout cognitive challenge module in accordance with one embodiment.

FIG. 2 illustrates an example challenge management module in accordance with an embodiment.

FIGS. 3-12 illustrate example cognitive challenges in accordance with various embodiments.

FIG. 13 illustrates an example flowchart of a workout with a combination of cognitive challenges described in FIGS. 3-12 in accordance with one embodiment.

FIG. 14 illustrates an example flowchart of a workout in accordance with one embodiment.

FIG. 15 illustrates an example of a computer system or computing device that can be utilized in various scenarios in accordance with one embodiment.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION OF THE PREFERRED EMBODIMENTS

An improved approach rooted in computer technology overcomes the disadvantages associated with conventional approaches specifically arising in the realm of computer technology. Based on computer technology, the present technology provides generation of cognitive challenges based on a workout comprising a plurality of defined movements (e.g., exercise movements). The movements can be selected from any categories of dance movements, claps, stomps, high-intensity intermittent training (HIIT) moves, resistance exercises, etc., or combinations thereof. A sequence of movements can be generated for the workout. A user of the present technology can be instructed to associate the movements with names or icons (or other computer-readable media content items) that correspond to the movements. In some embodiments, an icon can be a moving icon, such as an icon of “*.gif” extension. In some embodiments, an icon can be a snapshot of a performance of a movement. The instructions can be provided before the workout, during the workout (e.g., while the user is performing any of the movements), during break times, or after the workout. Cognitive challenges can be generated and provided to the user based on individual movements in the sequence.

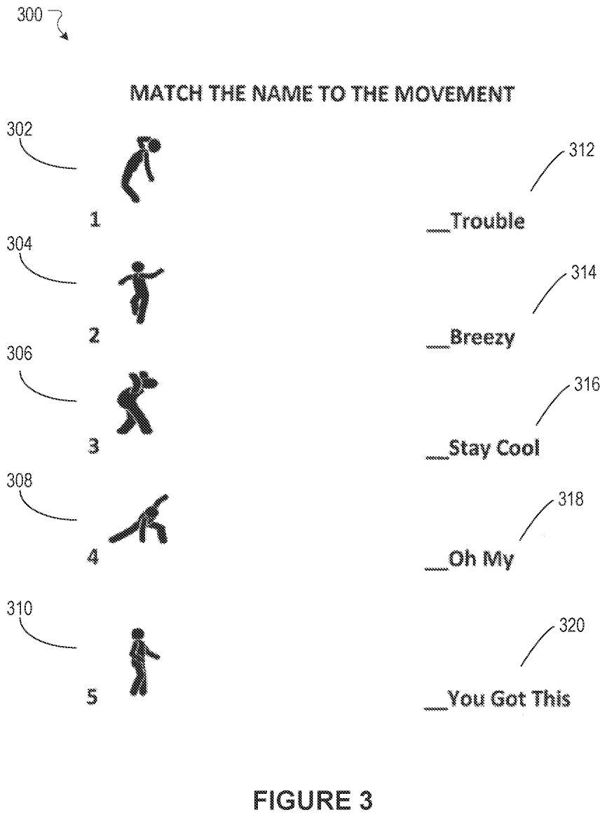

The cognitive challenges can prompt a user to identify one or more movements as answers to the cognitive challenges from memory. Some cognitive challenges can prompt the user to identify at least one movement. For example, the user can be provided a name of a movement and prompted to identify (e.g., select) an icon that corresponds to the movement, or vice versa. Some cognitive challenges can prompt the user to identify a correct order or a reverse order of the movements in the sequence. Some cognitive challenges can prompt the user to identify one or more movements that were in the sequence or, alternatively, not in the sequence. Examples of some cognitive challenges are further described in relation to FIGS. 3-12. The user can provide answers to the cognitive challenges in various ways. For example, the user may identify a movement by announcing a name of the movement into a microphone. As another example, the user may identify a movement by selecting the name or an icon that corresponds to the movement with use of a controller. As yet another example, the user may identify the movement by performing the movement to a camera. Accordingly, the workout can engage not only the cardiovascular and musculature systems, but also various aspects of the sensory and cognitive systems.

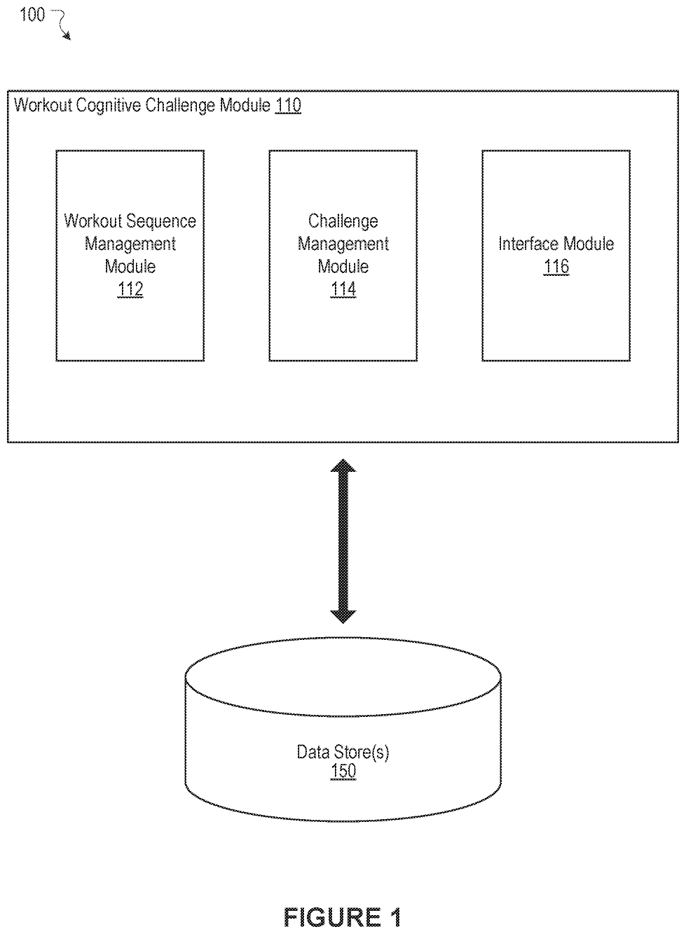

FIG. 1 illustrates an example system 100 including a workout cognitive challenge module 110, according to an embodiment of the present technology. The workout cognitive challenge module 110 can be configured to generate and manage a workout. Additionally, the workout cognitive challenge module 110 can generate and manage cognitive challenges based on movements provided in the workout. The workout cognitive challenge module 110 can interface with various input and output interfaces (e.g., devices) to effectuate the workout. Some example input interfaces can include sensors, cameras, microphones, controllers, or other human-machine interfaces (HMI). Some example output interfaces can include displays, speakers, or the like. The input and output interfaces can be implemented in or provided for immersive contexts, such as virtual reality or augmented reality contexts.

As shown in FIG. 1, the workout cognitive challenge module 110 can include a workout sequence management module 112, a challenge management module 114, and an interface module 116. It should be noted that the components (e.g., modules) shown in this figure and all figures herein are exemplary only, and other implementations may include additional, fewer, integrated or different components. Some components may not be shown so as not to obscure relevant details.

In some embodiments, the various modules and/or applications described herein can be implemented, in part or in whole, as software, hardware, or any combination thereof. In general, a module and/or an application, as discussed herein, can be associated with software, hardware, or any combination thereof. In some implementations, one or more functions, tasks, and/or operations of modules and/or applications can be carried out or performed by software routines, software processes, hardware, and/or any combination thereof. In some cases, the various modules and/or applications described herein can be implemented, in part or in whole, as software running on one or more computing devices or systems, such as on a user or client computing device or on a server. For example, one or more modules and/or applications described herein, or at least a portion thereof, can be implemented as or within an application (e.g., app), a program, or an applet, etc., running on a user computing device or a client computing system. In another example, one or more modules and/or applications, or at least a portion thereof, can be implemented using one or more computing devices or systems that include one or more servers, such as network servers or cloud servers. It should be understood that there can be many variations or other possibilities.

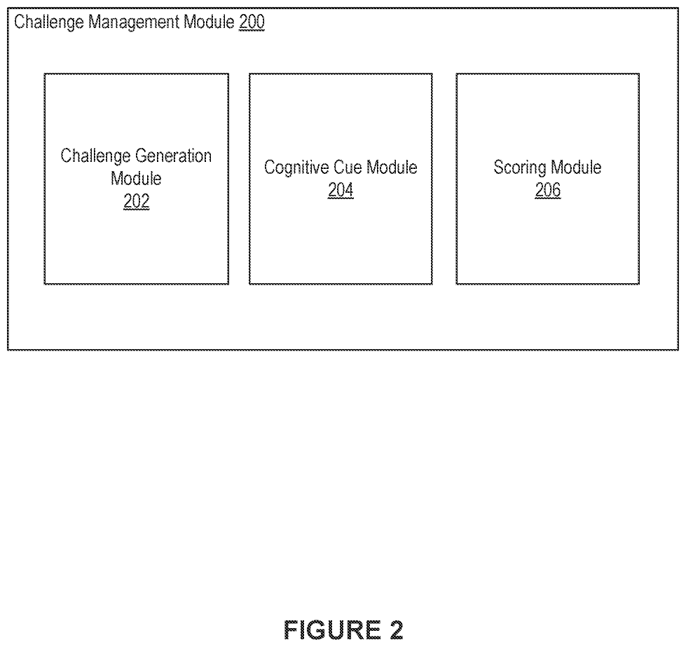

The workout sequence management module 112 can be configured to generate and manage a workout. As described, a workout can comprise a plurality of movements ordered in a sequence. The plurality of movements in the sequence can be a subset of a pool of all movements accessed from a data store 150. Each movement in the pool of all movements can be associated with one or more categories. For example, a movement can be associated with a category of dance moves and another category of calisthenics. In some embodiments, a user may select a category of workouts, such as “dance moves” and the workout sequence management module 112 can select movements in the selected category to generate a workout. In some embodiments, the plurality of movements can be selected for the workout based on whether selected movements have been presented to the user in the past or not. For example, the workout sequence management module 112 can access any past workouts from the data store 150 and select movements that have yet been presented to the user in order to further challenge user's different muscles and/or to make cognitive challenges more difficult. Conversely, the workout sequence management module 112 can select movements that have been presented to the user previously to facilitate further development of the user's muscle memory and to reduce difficulty of the cognitive challenges. In some instances, a combination of movements that have been presented to the user and that have not yet been presented to the user can be selected based on some metric, such as based on a 80%-20% rule. As will be described further in relation to a scoring module 208 of FIG. 2, each workout and constituent movements can be associated with scores. In some embodiments, the selection of the plurality of movements can be based on the scores associated with the workout or the constituent movements. For example, movements that the user has failed to correctly identify can be selected to adjust difficulty of the workout or the cognitive tests and/or to enhance learning of movements.

The workout sequence management module 112 can provide the sequence of the plurality of movements during the workout. The sequence can be provided as a list of ordered movements that are displayed on a screen or announced via a speaker. The list can comprise names and/or icons that correspond to the movements. Similarly, for each movement, a name or icon that corresponds to the movement can be displayed or announced. The name or icon can be provided before, during, or after a performance of the movement to expedite user memorization of their associations. In some instances, one or more aids, such as a video of an instructor performing a movement or an animation of the movement, can be provided in addition to or in lieu of the names and/or icons.

In some embodiments, an instructor can teach the plurality of movements in a pre-choreographed and/or pre-recorded video. The video can teach a user the plurality of movements in a particular order (e.g., according to the sequence) and the names of each movement, either through a verbal or visual identification. The pre-choreographed and/or pre-recorded video can be associated with one or more segment identifiers that each references a movement of the plurality of the movements. The workout sequence management module 112 can manage presentation of the plurality of movements in the sequence using the segment identifiers. For example, at various intervals during the video, a display screen can fade in or fade out to provide breaks and cognitive challenges. In some embodiments, the workout can be conducted in a face-to-face context between an instructor and a user.

In one embodiment, an instructor performs the method for a workout-training either face-to-face or via a non-interactive pre-recorded video. The method may comprise choreographing a plurality of exercise movements in a sequence; providing to a trainee each exercise movement of the plurality of exercise movements according to the sequence; and challenging the trainee's memory of the sequence. Challenging the trainee's memory of the sequence may comprise at least one of the following: (1) prompting the trainee to identify each exercise movement of the plurality of exercise movements in the sequence in original order; (2) prompting the trainee to identify each exercise movement of the plurality of exercise movements in the sequence in reverse order; (3) identifying a sample exercise movement of the plurality of exercise movements in the sequence and prompting the trainee to identify an exercise movement that is earlier or later in the sequence compared to the sample exercise movement; (4) prompting the trainee to identify an exercise movement based on a position of the exercise movement in the sequence; (5) prompting the trainee to identify a total number of exercise movements in the sequence; (6) prompting the trainee to identify exercise movements that are or are not in the sequence; and (7) providing a list of the plurality of exercise movements in a scrambled order and prompting the trainee to unscramble the list into the sequence.

In some instances, the workout sequence management module 112 can schedule iterations of the sequence in the workout. The iterations can include repeats (e.g., sets) of the sequence. An iteration can be for an original side of a movement or a mirror side of the movement. For example, some movements can initially focus on the left side of the user's body. The workout can include a first iteration of the movements for the left side followed by a second iteration of the same movements that focus on the right side of the user's body (e.g., mirror side). Accordingly, the workout can enhance muscular memory and cognitive memory of the user through the iterations.

The workout sequence management module 112 can manage progression of the workout including which movement comes prior to or after another movement. During each movement, a name, icon, and/or aid can be provided to the user kinesthetically, visually, and/or audibly. In some instances, the previous and next movements can similarly be presented to further enhance memorization of the movement's position in the sequence. In some embodiments, the current movement can be highlighted in a list of movements while the user is performing the movement. The workout sequence management module 112 can further manage progression of the workout over any number of iterations.

In some embodiments, the workout sequence management module 112 can insert break times between movements or iterations. During the break times, the workout sequence management module 112 can refresh the user of the sequence or provide cognitive challenges to the user.

The challenge management module 114 can be configured to generate and manage cognitive challenges. The challenge management module 114 can access a workout, sequence in the workout, and/or progression in the workout from the workout sequence management module 112. Based on the workout, sequence, and/or progression, one or more cognitive challenges can be generated and provided to a user via output interfaces managed by the interface module 116. The user's responses to the cognitive challenges can be received via input interfaces managed by the interface module 116. The user's responses can identify one or more movements in a sequence or the sequence itself. Based on whether the user has correctly identified the movements in the sequence or the sequence itself, the user's response can be scored. In some embodiments, scores of the cognitive challenges can be provided to the workout sequence management module 112, and the workout sequence management module 112 may dynamically adjust the workout based on the score. For example, when the challenge management module 114 determines that the user consistently misidentifies a particular movement, more or fewer aids can be provided for the particular movement. More details on the challenge management module 114 will be provided in relation to FIG. 2.

The interface module 116 can be configured to manage input and output interfaces. As described, the input interfaces can include sensors, cameras, microphones, controllers, or other human-machine interfaces (HMI). The controllers can include, for example, keyboard, mouse, gamepads, motion controllers, or the like. The HMI can include, for example, touch screens, gesture-based interfaces, virtual reality or augmented reality interfaces, or the like. Some of the output interfaces can include displays, speakers, virtual reality or augmented reality displays, or the like. In some instances the input and output interfaces can be implemented in the same device, such as touch-sensitive displays or interactive mirrors. In some embodiments, the interface module 116 can use various image recognition and movement detection techniques to capture and evaluate a user's performance of a movement.

The workout cognitive challenge module 110 may determine input and output interfaces that are available to the user and select available input and output interfaces for presentation of the workout and receipt of user responses. For example, when an interactive display screen (e.g., a touch-screen display) is not accessible to a user, the workout cognitive challenge module 110 may opt to receive a user's responses via announcements into a microphone or via performance of a movement to a camera.

As shown in FIG. 1, the workout cognitive challenge module 110 can be configured to communicate with a data store 150. The data store 150 can be configured to store and maintain various types of data to support the functionality of the workout cognitive challenge module 110 and its submodules. For example, the data store 150 can store and manage a pool of movements, names and icons associated with the movements, a plurality of selected movements in a sequence, a workout, progress in the sequence or the workout, scores of a user, a user profile including which movements have previously been presented to the user, kinesthetical, visual, and audio aids of the movements, instructions, challenge cues, music, sound effects, and any other information used or generated by the workout cognitive challenge module 110.

FIG. 2 illustrates an example challenge management module 200, according to an embodiment of the present technology. In some embodiments, the challenge management module 114 of FIG. 1 can be implemented as the challenge management module 200. As shown in the example of FIG. 2, the challenge management module 200 can include a challenge generation module 202, a cognitive cue module 204, and a scoring module 206.

The challenge generation module 202 can be configured to generate cognitive challenges based on movements in a workout. The challenge generation module 202 can access the workout, the movements, a sequence of the movements, etc. from the workout management module 112. The challenge generation module 202 can use various algorithms to generate various cognitive challenges. In some embodiments, different cognitive challenges can be associated with templates of the different cognitive challenges. The challenge generation module 202 may use the templates to generate various cognitive challenges.

A cognitive challenge can prompt a user to identify one or more movements with names or icons that correspond to the movements. The identification of the movements can be based on announcement of the names from the user into a microphone or by selection of the names/icons using a controller. Another cognitive challenge may provide the user with a superset of the movements that includes additional movements not included in the sequence and prompt the user to identify movements are or are not in the sequence. Yet another cognitive challenge may provide the user with a scrambled list of the movements and prompt the user to identify the correct sequence of the movements in the sequence (e.g., unscramble the scrambled list) or to identify a reverse sequence. Some variations of cognitive challenges are described in relation to FIGS. 3-12. Many more variations are possible.

The cognitive cue module 204 can be configured to provide kinesthetical, visual, or audible cues for the cognitive challenges. The cognitive cues can involve challenge prompts, such as “match the name of an exercise to the icon,” “match the icon to the name of an exercise,” “what is the next movement,” or “unscramble the movements into a correct order in the sequence.” In some instances, the cognitive cues can assist a user in identifying a correct answer. For example, a cue can be the music that was playing during a performance of a particular movement or a snapshot of a pose in the particular movement. Here, the snapshot may be a brief performance, such as a 1-second performance, of the particular movement.

The cognitive cues can involve hints, such as “this movement was a dance move in Michael Jackson's hit song Thriller,” “this movement came between ‘Stay Cool’ and ‘You Got This,’” “this movement includes a superman landing pose,” or “this movement engaged quadriceps.” The cognitive challenge module 204 may provide the hints in response to a request from the user. In some instances, a user can be provided a limited number of hints and may no longer request a hint once the user has exhausted the limited number. In some embodiments, requesting a hint may negatively affect a score determined by the scoring module 206. Many variations are possible.

The scoring module 206 can be configured to evaluate the performance of a user on the cognitive challenges with a score. The score can be a grade, a percentage score, or the like. The scoring module 206 can provide feedback on whether a user's response is correct or incorrect immediately upon completion of a cognitive challenge or after conclusion of a workout. The scoring module 206 may track the user's score and provide graphs of the user's past scores and the current score. In some embodiments, the user's score can be compared to scores of other users sharing similar demographics. For example, the scoring module 206 may inform the user that the user's score is better than 85% of similar users.

In some embodiments, the scoring module 206 may evaluate movement performances of a user. For example, in embodiments with a camera or other motion-capturing interface, a cognitive challenge may prompt a user to perform a movement. The performance can be evaluated using various image recognition and movement detection techniques. The scoring module 206 may generate a score based on how accurately the performance reflects the movement and, in some instances, may make suggestions to improve the user's pose or posture. Many variations are possible.

FIGS. 3-12 show example cognitive challenges in accordance with various embodiments. For FIGS. 3-12, it is assumed that a plurality of movements selected for a workout includes five movements, where their names and corresponding icons are:
“Trouble”, which corresponds to the first icon 302;
“Breezy”, which corresponds to the second icon 304;
“Oh My”, which corresponds to the third icon 306;
“Stay Cool”, which corresponds to the fourth icon 308; and
“You Got This”, which corresponds to the fifth icon 310.
   In some instances, descriptive names and icons can be provided to facilitate formation of mental associations. In some instances, less descriptive (e.g., arbitrary or fanciful) names and icons can be provided to increase difficulty in the formation of mental associations. In other embodiments, the movement name can be a sound, a color, an image, or some combination of sounds, colors, images, or other indicia. In some embodiments, greater or fewer than five movements can be selected for a workout.

FIG. 3 illustrates a cognitive challenge 300 that prompts a user to match icons 302, 304, 306, 308, 310 representing movements to names 312, 314, 316, 318, 320 that correspond to the movements. The icons 302, 304, 306, 308, 310 can be static icons or dynamic icons (e.g., “*.gif” images). The icons 302, 304, 306, 308, 310 and the names 312, 314, 316, 318, 320 are presented during the workout such that the user can make mental associations between the icons 302, 304, 306, 308, 310, the names 312, 314, 316, 318, 320, and corresponding movements. Here, the user is prompted to identify each name that corresponds to an icon. Based on the assumed order of the movements in the sequence, the correct answer is {1, 2, 4, 3, 5}.

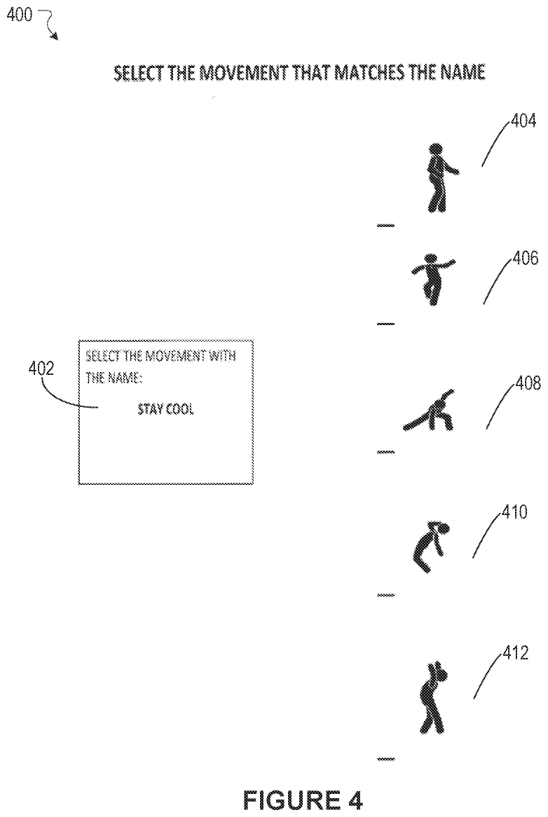

FIG. 4 illustrates a cognitive challenge 400 that prompts a user to identify one icon that corresponds to the “Stay Cool” 402 movement. Compared to the previous cognitive challenge 300, the order of icons 404, 406, 408, 410, 412 can be scrambled to increase difficulty of this cognitive challenge cognitive 400. According to the assumption, the correct association for the movement “Stay Cool” 402 is the third icon 408. The user may identify the third icon 408 as the correct answer by selecting the third icon 408.

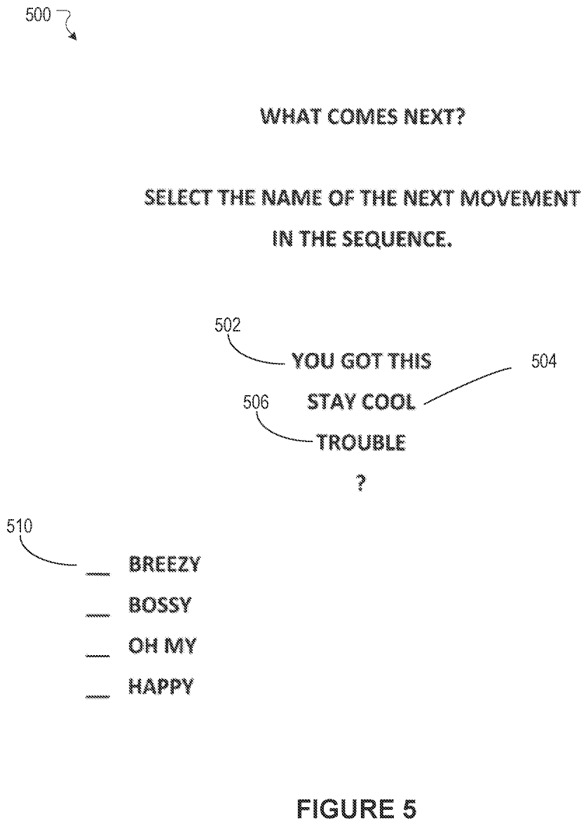

FIG. 5 illustrates a cognitive challenge 500 that prompts a user to identify a name of the next movement that follows three other movements 502, 504, 506 in the sequence. According to the assumption, the next movement is “Breezy” of the first option 510. The user may identify the first option 510 “Breezy” as the correct answer by selecting the first option 510 or announcing “Breezy.”

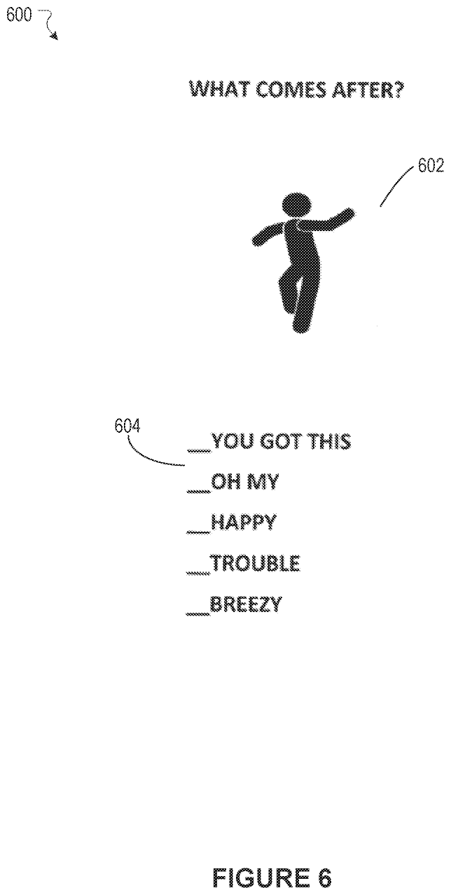

FIG. 6 illustrates a cognitive challenge 600 that prompts a user to identify the next movement that follows the “Breezy” movement, represented by an icon 602, in the sequence and to identify a name that corresponds to the next movement. According to the assumption, the next movement that follows “Breezy” is “Oh My.” The user may identify the second option 604 “Oh My” as the correct answer by selecting the second option 604 or announcing “Oh My.”

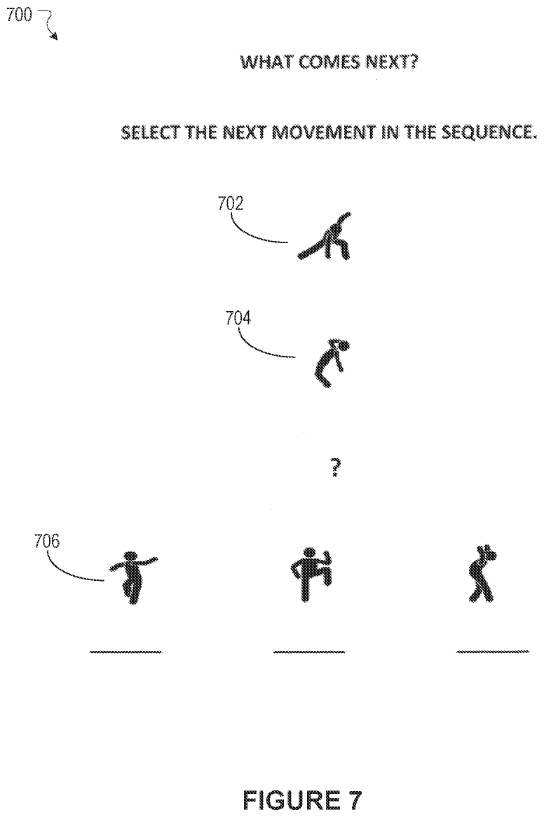

FIG. 7 illustrates a cognitive challenge 700 that prompts a user to identify an icon of the next movement that follows two other movements 702, 704 in the sequence. According to the assumption, the next movement is “Breezy” movement that is represented by the first icon 706. The user may identify the first icon 706 as the correct answer by selecting the first icon 706.

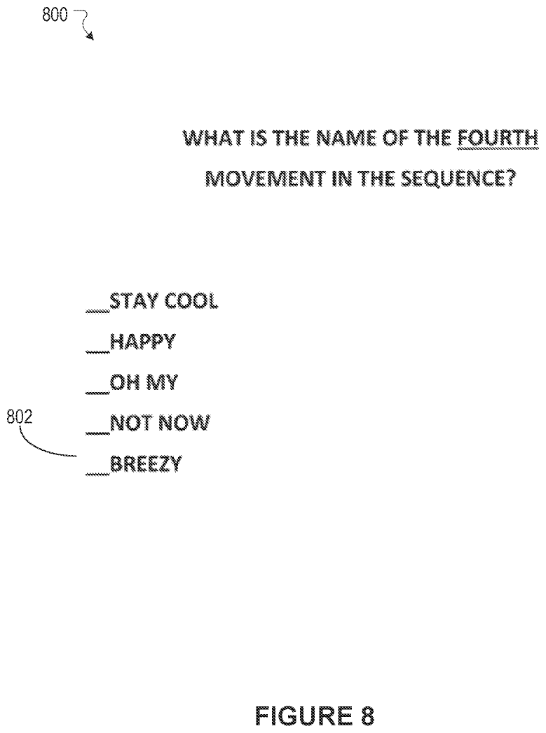

FIG. 8 illustrates a cognitive challenge 800 that prompts a user to identify a name of the fourth exercise in the sequence. According to the assumption, the fourth movement is “Breezy” movement that is represented by the fifth option 802. The user may identify the fifth option 802 as the correct answer by selecting the fifth option 802 or announcing “Breezy”.

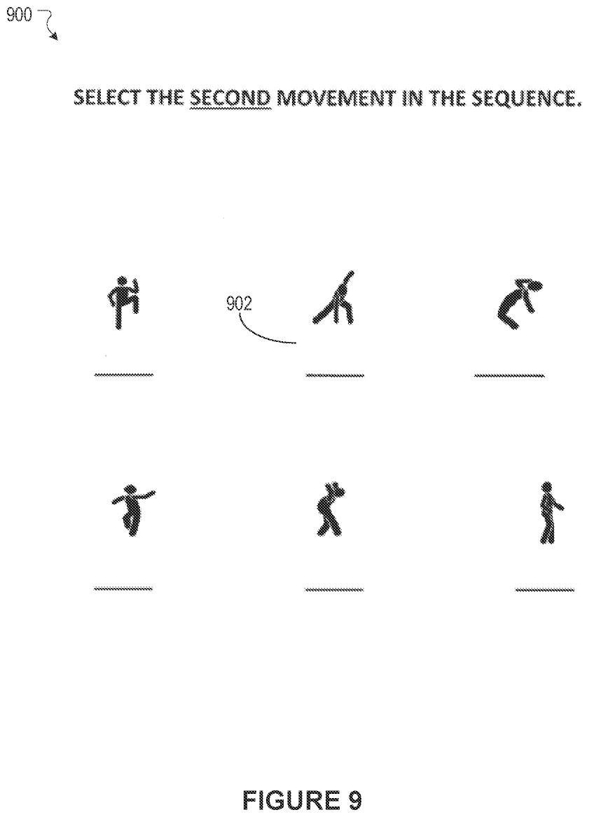

FIG. 9 illustrates a cognitive challenge 900 that prompts a user to identify an icon that corresponds to the second movement in the sequence. According to the assumption, the second movement is “Stay Cool” that is represented by the icon 902 in the first row and second column. The user may identify the icon 802 as the correct answer by selecting the icon 802.

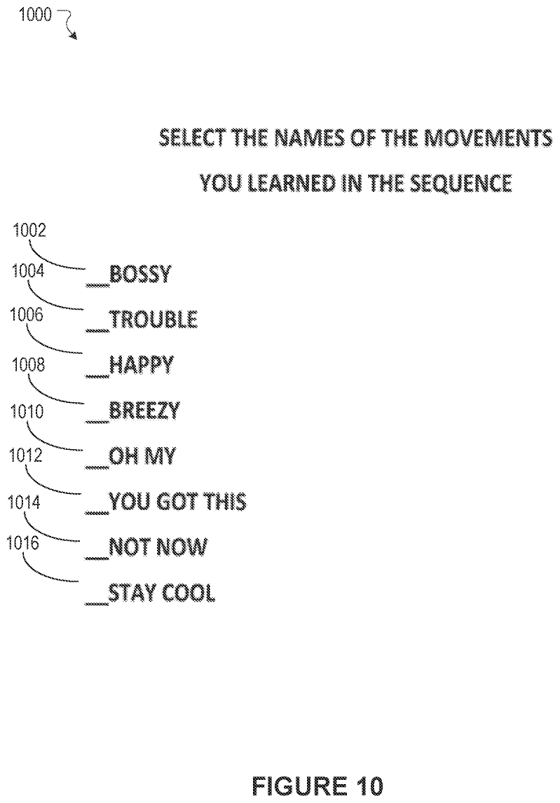

FIG. 10 illustrates a cognitive challenge 1000 that prompts a user to identify all names of the movements in the sequence from a list of names of movements. As illustrated, “Bossy” 1002, “Happy” 1006, and “Not Now” 1014 are movements not in the sequence. According to the assumption, “Trouble” 1004, “Breezy” 1008, “Oh My” 1010, “You Got This” 1012, and “Stay Cool” 1016 are movements in the sequence. The user may identify “Trouble” 1004, “Breezy” 1008, “Oh My” 1010, “You Got This” 1012, and “Stay Cool” 1016 as the correct answer by selecting options corresponding to the movements or announcing the names of the movements.

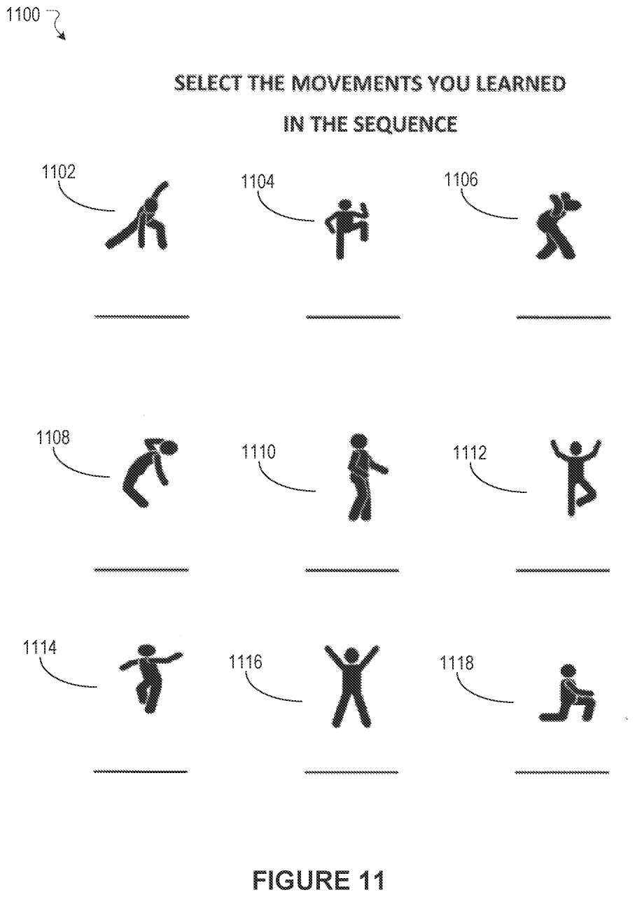

FIG. 11 illustrates a cognitive challenge 1100 that prompts a user to identify all icons that correspond to the movements in the sequence from a list of icons. As illustrated, some of the icons 1104, 1112, 1116, 1118 represent movements not in the sequence. According to the assumption, icons 1102, 1106, 1108, 1110, 1114 (corresponding to “Stay Cool,” “Oh My,” “Trouble,” “You Got This,” and “Breezy” in that order) are movements in the sequence. The user may identify the icons 1102, 1106, 1108, 1110, 1114 as the correct answer by selecting options corresponding to the movements.

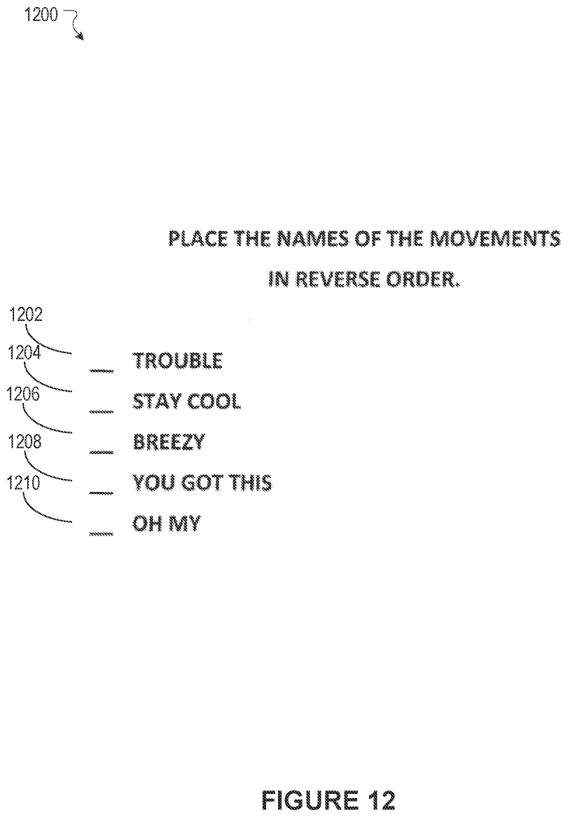

FIG. 12 illustrates a cognitive challenge 1200 that prompts a user to identify a reverse sequence of the movements in the sequence. In the assumption, the sequence is “You Got This,” “Stay Cool,” “Trouble,” “Breezy,” and “Oh My.” Thus, the reverse sequence is “Oh My,” “Breezy,” “Trouble,” “Stay Cool,” and “You Got This.” The user may identify the names of movements in the reverse order by entering the correct answer {3, 4, 2, 5, 1}, by selecting the fifth option 1210, third option 1206, first option 1202, second option 1204, and the fourth option 1208 in that order, or by announcing the names in that order.

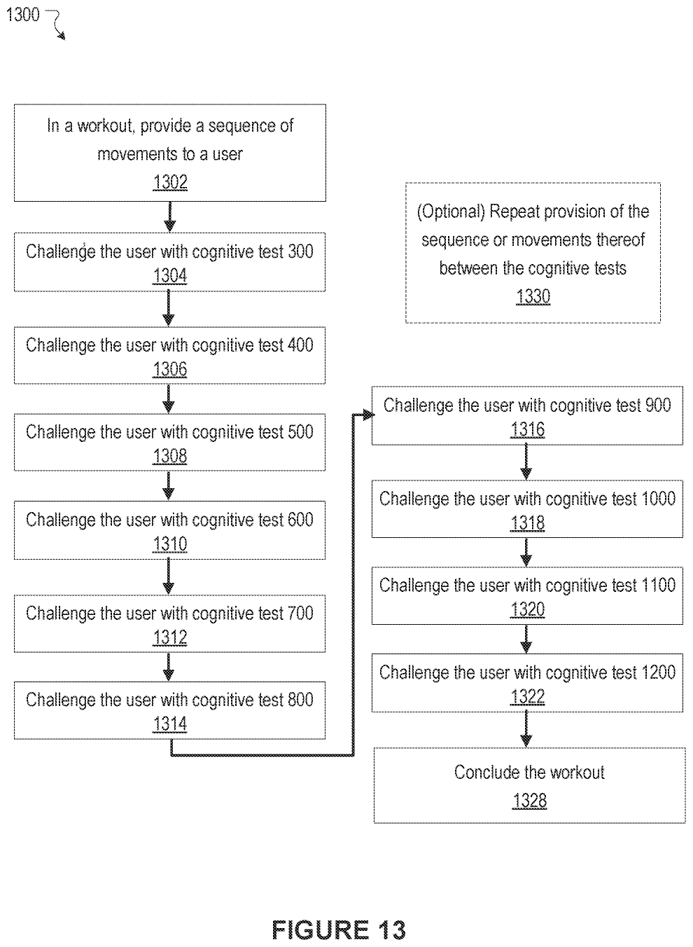

The example cognitive challenges described in relation to FIGS. 3-12 are for illustrative purposes only. It is contemplated that various combinations of the cognitive challenges or portions thereof are possible, as will be described in relation to FIG. 13.

FIG. 13 illustrates an example flowchart of a workout with a combination of cognitive challenges, in accordance with one embodiment. At block 1302, a sequence of movements is provided to a user for a workout. The movements can be provided along with names or icons that correspond to the movements. In some instances, the icons can be snapshots or videos, including small portions of the videos, of the movements. The sequence can be provided to the user in a video which, in some instances, can be an interactive video. The video can be of an instructor or an animation describing and/or performing the movements. The user may control playback of the sequence. In some embodiments, the video can be an interactive video that determines next content based on user responses. The video demonstrates and teaches the user the sequence of movements and a name for each movement. The user may follow along with the video while performing the sequence of movements any number of times. In some embodiments, the user can be prompted to announce the names of the movements while the user practices performing the movements. In some embodiments, the video can gradually fade out during the practice and the user may be asked to continue practice performing the sequence on her/his own a plurality of times. This fading out of the video can force the user to attempt to recall the movements in the sequence in real time while performing the movements. After varying amounts of time, the video can fade back, thereby allowing the user to determine whether the user is performing the movements correctly in the sequence. In one embodiment, the sequence of movements can be performed to music. In another embodiment, the music can be played at varying tempos.

At block 1304, the user can be provided with the cognitive challenge 300. The user can be provided with a screen having the names of the movements in a random order and can be prompted to input the names of the movements in a correct order. In some embodiments, a split screen or a second screen can be used to provide demonstrations of the exercise movements.

At block 1306, the user can be provided with the cognitive challenge 400. The user can be provided with a name of a movement and be prompted to identify an icon that matches the name. In the cognitive challenge 400, the user can be provided with a plurality of movements in a random order. Some of the movements may or may not be movements in the sequence.

At block 1308, the user can be provided with the cognitive challenge 500. The user can be provided with names of movements in an order. The user can be prompted to identify which movement comes next in the sequence by identifying a correct name of the next movement. Some of the names may or may not be of movements in the sequence.

At block 1310, the user can be provided with the cognitive challenge 600. The user can be provided with an icon that represents a movement and a list of names of movements. The user can be prompted to identify which movement comes next by identifying a correct name of the next movement.

At block 1312, the user can be provided with the cognitive challenge 700. The user can be provided with icons that represent movements in an order. The user can be prompted to identify which movement comes next by selecting an icon representing the next movement from a randomly ordered set of icons.

At block 1314, the user can be provided with the cognitive challenge 800. The user can be provided with a list of names of movements. For example, the user can be prompted to identify the name of a movement that is the fourth movement in the sequence. In some instances, the list of names of movements can include names of movements not taught in the sequence to further challenge the user.

At block 1316, the user can be provided with the cognitive challenge 900. The user can be provided with a list of icons that represent movements. For example, the user can be prompted to identify an icon that represents the second movement in the sequence. In some instances, the list of icons can include icons corresponding to movements not taught in the sequence to further challenge the user.

At block 1318, the user can be provided with the cognitive challenge 1000. The user can be provided with a list of names of movements. The user can be prompted to identify names of movements taught in the sequence. In some embodiments, the cognitive challenge 1000 can be modified to prompt the user to identify names of movements not taught in the sequence.

At block 1320, the user can be provided with the cognitive challenge 1100. The user can be provided with icons representing movements. The user can be prompted to identify icons that correspond to movements taught in the sequence. In some embodiments, the cognitive challenge 1100 can be modified to prompt the user to identify icons corresponding to movements not taught in the sequence.

At block 1324, the user can be provided with the cognitive challenge 1200. The user can be provided with a random order of names of movements in the sequence. The user can be prompted to input the names of movements in a reverse order of the sequence (i.e., from the last movement to the first movement).

The cognitive tests can be scored after each cognitive test or after the workout. In some embodiments, the user can be asked to perform or repeat the movements during or between the cognitive challenges as illustrated in an optional block 1330 to refresh the user's muscular and cognitive memory. Further, the user can be asked to perform the movements on the mirror side. Movements in the sequence can originally focus on the left side of the user's body. The user can be prompted to perform the movements on the mirror side (e.g., opposite side) to focus on the right side of the user's body. For example, if the sequence starts with the right foot moving to the left, the user can be asked to start with the left foot moving to the right. Some cognitive challenges can prompt the user to answer one or more questions about performing the sequence on the opposite side. For example, a question can be “when you perform the sequence on the opposite side, which knee bends in a lunge when performing the movement Trouble?”

At any point in the workout, new movements can be added to the sequence to gradually increase the difficulty of the cognitive challenges. Later, the user can be prompted to identify a total number of movements in the original sequence or the expanded sequence. The new movements can be added at any position in the sequence.

Further, at any point in the workout, the user can be instructed to perform one or more exercises or movements that are not in the sequence. For example, weights, sit ups, squats, etc. can engage the user to continue to exercise, but can be unrelated to movements in the sequence. The unrelated exercises or movements can distract the user and can increase the difficulty of the cognitive challenges. Many variations are possible.

At block 1328, the workout can conclude. Scores of the user's responses of the cognitive challenges can be determined and provided as numbers, grades, and/or graphs.

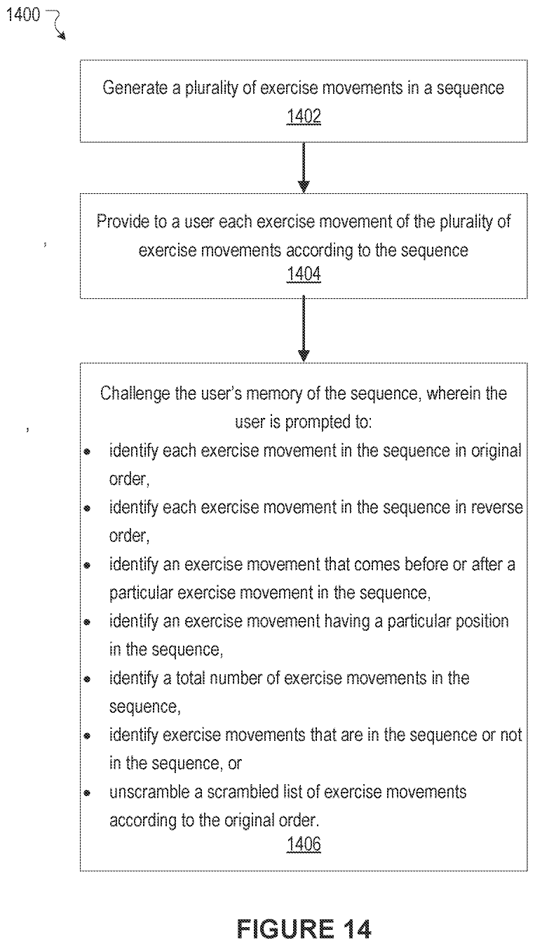

FIG. 14 illustrates an example flowchart of a workout in accordance with one embodiment. At block 1402, a plurality of exercise movements in a sequence can be generated. At block 1404, a user can be provided with each exercise movement of the plurality of exercise movements according to the sequence. At block 1406, the user's memory can be challenged. The user can be prompted to identify each exercise movement in the sequence in original order. The user can be prompted to identify each exercise movement in the sequence in reverse order. The user can be prompted to identify an exercise movement that comes before or after a particular exercise movement in the sequence. The user can be prompted to identify an exercise movement having a particular position in the sequence. The user can be prompted to identify a total number of exercise movements in the sequence. The user can be prompted to identify exercise movements that are in the sequence or not in the sequence. The user can be prompted to unscramble a scrambled list of exercise movements according to the original order. Before, during, or after the challenge to the user's memory, the user can be directed to perform the various exercise movements.

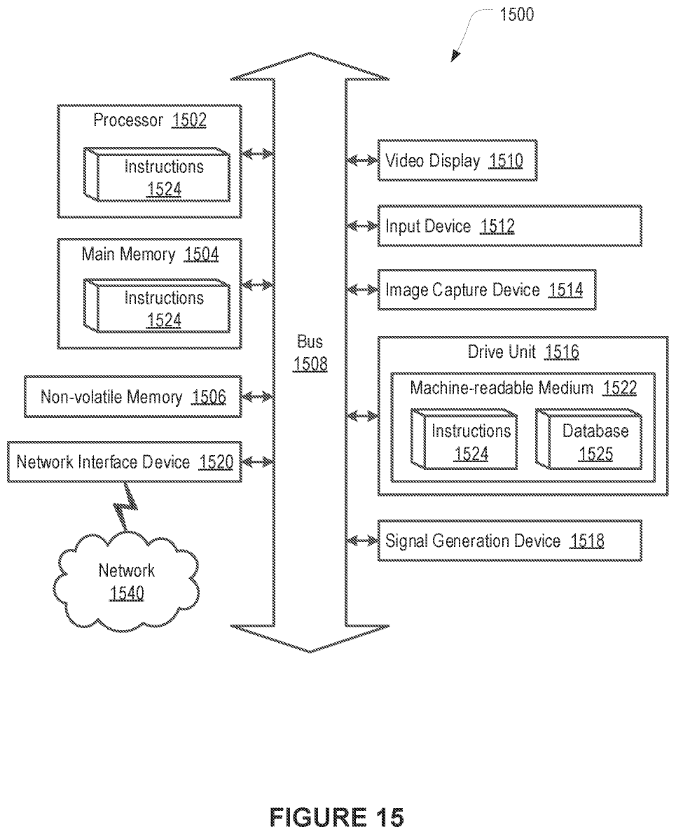

The foregoing processes and features can be implemented by a wide variety of machine and computer system architectures and in a wide variety of network and computing environments. FIG. 15 illustrates an example of a computer system 1500 that may be used to implement one or more of the embodiments described herein according to an embodiment of the invention. The computer system 1500 includes sets of instructions 1524 for causing the computer system 1500 to perform the processes and features discussed herein. The computer system 1500 may be connected (e.g., networked) to other machines and/or computer systems. In a networked deployment, the computer system 1500 may operate in the capacity of a server or a client machine in a client-server network environment, or as a peer machine in a peer-to-peer (or distributed) network environment.

The computer system 1500 includes a processor 1502 (e.g., a central processing unit (CPU), a graphics processing unit (GPU), or both), a main memory 1504, and a nonvolatile memory 1506 (e.g., volatile RAM and non-volatile RAM, respectively), which communicate with each other via a bus 1508. In some embodiments, the computer system 1500 can be a desktop computer, a laptop computer, personal digital assistant (PDA), or mobile phone, for example. In one embodiment, the computer system 1500 also includes a video display (e.g., a display screen, touchscreen, interactive display, interactive mirror, virtual reality or augmented reality display, or the like) 1510, at least one input device 1512 (e.g., a keyboard, mouse, gamepads, motion controllers, or the like), an image capture device 1514 (e.g., a camera), a drive unit 1516, a signal generation device 1518 (e.g., a speaker) and a network interface device 1520.

In one embodiment, the video display 1510 includes a touch sensitive screen for user input. In one embodiment, the touch sensitive screen is used instead of a keyboard and mouse. The disk drive unit 1516 includes a machine-readable medium 1522 on which is stored one or more sets of instructions 1524 (e.g., software) embodying any one or more of the methodologies or functions described herein. The instructions 1524 can also reside, completely or at least partially, within the main memory 1504 and/or within the processor 1502 during execution thereof by the computer system 1500. The instructions 1524 can further be transmitted or received over a network 1540 via the network interface device 1520. In some embodiments, the machine-readable medium 1522 also includes a database 1525.

Volatile RAM may be implemented as dynamic RAM (DRAM), which requires power continually in order to refresh or maintain the data in the memory. Nonvolatile memory is typically a magnetic hard drive, a magnetic optical drive, an optical drive (e.g., a DVD RAM), or other type of memory system that maintains data even after power is removed from the system. The non-volatile memory 1506 may also be a random access memory. The non-volatile memory 1506 can be a local device coupled directly to the rest of the components in the computer system 1500. A non-volatile memory that is remote from the system, such as a network storage device coupled to any of the computer systems described herein through a network interface such as a modem or Ethernet interface, can also be used.

While the machine-readable medium 1522 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar nontransitory (or transitory), tangible (or non-tangible) storage medium; or any type of medium suitable for storing, encoding, or carrying a series of instructions for execution by the computer system 1500 to perform any one or more of the processes and features described herein.

In general, routines executed to implement the embodiments of the invention can be implemented as part of an operating system or a specific application, component, program, object, module or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 1500 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually effect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

It should be appreciated from the foregoing description that the present invention provides a user with a physical workout of the cardiovascular and muscular systems, as well as an intense mental workout, which challenges the user's memory and ability to recall and manipulate a sequence of items (i.e., movements and movement names). Short-term memory can be further challenged by increasing the number of movements in a sequence and by adding additional manipulations to the sequence order. In addition, long-term memory can be challenged during subsequent sessions by asking the user to recall previously-learned sequences of movements.

Specific methods, devices, and materials are described, although any methods and materials similar or equivalent to those described can be used in the practice or testing of the present embodiment. Unless defined otherwise, all technical and scientific terms used herein have the same meanings as commonly understood by one of ordinary skill in the art to which this embodiment belongs. The terms “a,” “an,” and “at least one” encompass one or more of the specified element. That is, if two of a particular element are present, one of these elements is also present and thus “an” element is present. The terms “a plurality of” and “plural” mean two or more of the specified element. The term “or” used between the last two of a list of elements means any one or more of the listed elements. For example, the phrase “A, B, or C” means “A, B, and/or C,” which means “A,” “B,” “C,” “A and B,” “A and C,” “B and C,” or “A, B, and C.”

Without further elaboration, it is believed that one skilled in the art, using the proceeding description, can make and use the present invention to the fullest extent. The invention has been described in detail with reference only to the presently preferred embodiments. Persons skilled in the art will appreciate that various modifications can be made without departing from the invention. Accordingly, the invention is defined only by the following claims. Numerous variations, changes, and substitutions will be used without departing from the invention. It should be understood that various alternatives to the embodiments of the invention described herein may be employed in practicing the invention.

1. A computer-implemented method for a workout-training, the method comprising:
generating, by a computing system, a plurality of exercise movements in a sequence;
providing, by the computing system, to a user each exercise movement of the plurality of exercise movements according to the sequence; and
challenging, by the computing system, the user's memory of the sequence, wherein the challenging the user's memory of the sequence comprises at least one of:
prompting the user to identify each exercise movement of the plurality of exercise movements in the sequence in original order;
prompting the user to identify each exercise movement of the plurality of exercise movements in the sequence in reverse order;
identifying a sample exercise movement of the plurality of exercise movements in the sequence and prompting the user to identify an exercise movement that is later in the sequence compared to the sample exercise movement;
identifying a sample exercise movement of the plurality of exercise movements in the sequence and prompting the user to identify an exercise movement that is earlier in the sequence compared to the sample exercise movement;
prompting the user to identify an exercise movement based on a position of the exercise movement in the sequence;
prompting the user to identify a total number of exercise movements in the sequence;
prompting the user to identify exercise movements that are in the sequence;
prompting the user to identify exercise movements that are not in the sequence; and
providing a list of the plurality of exercise movements in a scrambled order and prompting the user to unscramble the list into the sequence.

2. The computer-implemented method of claim 1, further comprising:
providing at least one performing aid including performances of the plurality of exercise movements in the sequence;
providing a plurality of names, wherein each name of the plurality of names corresponds to a respective exercise movement; and
prompting the user to follow the at least one performing aid.

3. The computer-implemented method of claim 2, wherein the at least one performing aid is stopped before the challenging the user's memory of the sequence.

4. The computer-implemented method of claim 3, further comprising:
providing a list of names or icons of the plurality of exercise movements in an order of the sequence.

5. The computer-implemented method of claim 1, further comprising:
prompting the user to perform the plurality of exercise movements on a mirror side.

6. The computer-implemented method of claim 1, further comprising:
providing a plurality of names or icons that corresponds to the plurality of exercise movements,
wherein the prompting the user to identify the exercise movement comprises prompting the user to identify the name or the icon that corresponds to the exercise movement.

7. The computer-implemented method of claim 6, wherein the prompting the user to identify the exercise movement comprises:
providing the name and prompting the user to identify the icon that corresponds to the name; or
providing the icon and prompting the user to identify the name that corresponds to the icon.

8. The computer-implemented method of claim 1, wherein the prompting the user to identify exercise movements that are in the sequence comprises:
providing a list including the plurality of exercise movements and additional exercise movements not in the sequence.

9. The computer-implemented method of claim 1, further comprising:
generating a score based on whether the user has successfully identified the exercise movement.

10. The computer-implemented method of claim 1, further comprising:
tracking a set of exercise movements that the user has not successfully identified; and
generating a subset of the plurality of exercise movements based on the set of exercise movements.

11. The computer-implemented method of claim 1, further comprising:
providing a plurality of names that corresponds to the plurality of exercise movements;
providing a microphone to the user, wherein the prompting the user to identify the exercise movement comprises prompting to user to announce a name that corresponds to the exercise movement into the microphone; and
receiving the name from the user via the microphone.

12. The computer-implemented method of claim 1, further comprising:
providing a plurality of performing aids including performances of the plurality of exercise movement;
providing a camera to the user, wherein the prompting the user to identify the exercise movement comprises prompting to user to perform the exercise movement; and
receiving the user's performance via the camera.

13. The computer-implemented method of claim 12, further comprising:
evaluating a pose or posture of the user's performance using image recognition; and
providing a suggestion to improve the pose or posture.

14. The computer-implemented method of claim 1, further comprising:
providing a plurality of performing aids including performances of the plurality of exercise movement;
providing at least one controller to the user, wherein the prompting the user to identify the exercise movement comprises prompting to user to perform the exercise movement; and
receiving the user's performance via the at least one controller.

15. The computer-implemented method of claim 1, further comprising:
providing a breakout time before the challenging the user's memory of the sequence.

16. The computer-implemented method of claim 1, further comprising:
adding at least one new movement to the plurality of exercise movements; and
updating the plurality of exercise movements in the sequence to include the new movement.

17. The computer-implemented method of claim 1, further comprising:
prompting the user to perform an exercise movement not in the sequence.

18. The computer-implemented method of claim 1, wherein the challenging the user's memory of the sequence comprises:
providing at least one hint in association with a correct answer.

19. A system comprising:
at least one hardware processor; and
a memory storing instructions that, when executed by the at least one processor, cause the system to perform:
generating a plurality of exercise movements in a sequence;
providing to a user each exercise movement of the plurality of exercise movements according to the sequence; and
challenging the user's memory of the sequence, wherein the challenging the user's memory of the sequence comprises at least one of:
prompting the user to identify each exercise movement of the plurality of exercise movements in the sequence in original order;
prompting the user to identify each exercise movement of the plurality of exercise movements in the sequence in reverse order;
identifying a sample exercise movement of the plurality of exercise movements in the sequence and prompting the user to identify an exercise movement that is later in the sequence compared to the sample exercise movement;
identifying a sample exercise movement of the plurality of exercise movements in the sequence and prompting the user to identify an exercise movement that is before in the sequence compared to the sample exercise movement;
prompting the user to identify an exercise movement based on a position of the exercise movement in the sequence;
prompting the user to identify a total number of exercise movements in the sequence;
prompting the user to identify exercise movements that are in the sequence;
prompting the user to identify exercise movements that are not in the sequence; and
providing a list of the plurality of exercise movements in a scrambled order and prompting the user to unscramble the list into the sequence.

20. A non-transitory computer-readable medium including instructions that, when executed by at least one hardware processor of a computing system, cause the computing system to perform a method comprising:
generating a plurality of exercise movements in a sequence;
providing to a user each exercise movement of the plurality of exercise movements according to the sequence; and
challenging the user's memory of the sequence, wherein the challenging the user's memory of the sequence comprises at least one of:
prompting the user to identify each exercise movement of the plurality of exercise movements in the sequence in original order;
prompting the user to identify each exercise movement of the plurality of exercise movements in the sequence in reverse order;
identifying a sample exercise movement of the plurality of exercise movements in the sequence and prompting the user to identify an exercise movement that is later in the sequence compared to the sample exercise movement;
identifying a sample exercise movement of the plurality of exercise movements in the sequence and prompting the user to identify an exercise movement that is before in the sequence compared to the sample exercise movement;
prompting the user to identify an exercise movement based on a position of the exercise movement in the sequence;
prompting the user to identify a total number of exercise movements in the sequence;
prompting the user to identify exercise movements that are in the sequence;
prompting the user to identify exercise movements that are not in the sequence; and
providing a list of the plurality of exercise movements in a scrambled order and prompting the user to unscramble the list into the sequence.
